(19) United States
(12) Patent Application Publication
(10) Pub. No.: US 2012/0162733 A1
(43) Pub. Date: Jun. 28, 2012

(54) METHOD FOR CONTROLLING DEPTH-OF-FOCUS IN 3D IMAGE RECONSTRUCTIONS, IN PARTICULAR FOR SYNTHESIZING THREE-DIMENSIONAL DYNAMIC SCENE FOR THREE-DIMENSIONAL HOLOGRAPHY DISPLAY, AND HOLOGRAPHIC APPARATUS UTILIZING SUCH A METHOD

(75) Inventors: Pietro Ferraro, Pozzuoli (NA) (IT); Melania Paturzo, Pozzuoli (NA) (IT); Pasquale Memmolo, Pozzuoli (NA) (IT); Andrea Finizio, Pozzuoli (NA) (IT)

(73) Assignee: Consiglio Nazionale Delle Ricerche, Piazzale Aldo Moro, Roma (IT)

(21) Appl. No.: 13/261,087

(22) PCT Filed: Jun. 25, 2010
(86) PCT No.: PCT/IT2010/000281

§ 371 Date: Mar. 12, 2012

(30) Foreign Application Priority Data
Jun. 26, 2009 (IT) RM2009A000331

(51) Int. Cl. G03H 1/08

(52) U.S. Cl. 359/9

(57) ABSTRACT

The invention concerns a method for controlling depth-of-focus in 3D image reconstructions, in particular for:
A) Controlling the focus with the aim to synthesize a holography dynamic 3D scene; such a scene can be either numerically reconstructed or holographically projected for 3D display purposes by means of optical reconstruction through Spatial Light Modulator (SLM);
B) controlling the focus to extend the depth of focus and have two object at different distance simultaneously in focus by digital holography;

The method according to the invention can be applied with few differences both to the usual holograms and to the Fourier ones.

The invention further concerns a holographic apparatus implementing the method according to the invention:

The present invention concerns a method for controlling depth-of-focus in 3D image reconstructions, in particular for synthesizing three-dimensional dynamic scene for three-dimensional holography display, and holographic apparatus utilizing such a method.

The invention can find useful exploitation in two different fields of three-dimensional imaging:
A) Controlling of focus with the aim of synthesizing a holography dynamic 3D scene; such a scene can be either numerically reconstructed or holographically projected for 3D display purposes by means of optical reconstruction through Spatial Light Modulator (SLM);
B) Controlling the focus in the reconstruction process with the aim to extend the depth of focus and have for example two objects at different distance simultaneously in focus by digital holography.

In the following, it will be described in details how the present invention allows to overcome the state of the art in the above fields of application (A) and (B) by the same simple procedure for manipulating digital holograms.

More precisely, the present invention relates to a method by means of which a 3D dynamic scene can be projected avoiding complex and heavy computations for generating CGHs (computer generated holograms). The key tool for creating the dynamic action is based on a completely new and simple procedure that consist in the spatial, optimization transformation of optically recorded digital holograms that allows the complete control and manipulation of the object's position and size in a 3D volume with very high depth-of-focus (tens of centimetres).

A full 3D scene is synthesized by combining, coherently, multiple holograms of one or more objects. Such synthetic holograms can be optically displayed in 3D.

The novel idea consists in building-up and making in action a synthetic 3D scene with a process that is analogous to “cartoons” movie or “muppets-show” movie but in this case the movie has the challenging attribute to be displayed and observed in 3D with very high depth of focus. The invention further concerns the means that provide the apparatuses and instruments necessary for carrying out the method according to the invention, as well as a holographic apparatus employing the method according to the invention.

Since from its discovery, made by Dennis Gabor [1], holography has prefigured the expectation for a spectacular 3D imaging and display system. Classical holography, based on photosensitive films and plates had their main limitation in the chemical processing and single-shot procedure. Other recording media such as photorefractive crystals and polymers, thermoplastic, photopolymers film also suffer of other and different kinds of limitations for practical implementation of a satisfying holographic and dynamic 3D display even if relevant improvements have been achieved recently that lead one to be optimistic for medium long term technological development [2-20].

The arrival of solid state sensors in '70s has opened the new era of Digital Holography (DH). However, despite the tremendous technological progress of solid state sensors, they have not surpassed yet the most notable spatial resolution (more than 5000 lines/mm) of classical recording materials. Nevertheless, the expectation about spectacular 3D display is now be entrusted to DH. Holograms are digitally recorded, directly and very fast, by CCD sensor or CMOS matrix sensors. The reconstruction can be performed numerically, for display in 3D, by a spatial light modulator (SLM).

Even if the expectations for an efficient and high quality 3D system are waiting to be met since from long time, the interest is still much important due to the huge industrial and economic interests and because the promise of such human-wise and natural way of observation is very fascinating and stimulating for everyone.

The synthesis of dynamic 3D scenes can be useful in many cases, such as display of 3D scenes for surgery training and/or simulation for entertainment purposes, e.g. for the realization of 3D movies.

Considerable progresses have been made in recent years about 3D imaging and display along different development directions. Holography remains the main and most challenging approach. In fact, generally speaking, only by means of holography it is possible to have the breakthrough toward the “true” 3D imaging without passing through a “surrogate” such as stereoscopic vision and other ways that require for example special eyewear. Holography, in principle, is the only way to allow full parallax and depth perception without misinforming the human brain giving merely the psychological visual depth cue and 3D view.

Most of the brilliant achievements in holographic 3D display that have been reported, were obtained by the realization of CGHs. In one particular approach the dynamic 3D display is obtained by using an acousto-optic modulator, a liquid crystal spatial modulator, and a digital micro-mirrors. In a more recent paper, it has been reported the challenging result of having a photorefractive polymer recording plate with updatable holographic recording. Such registration plates can be utilized for the recording of computer-synthesized holograms (CGH) [6].

Numerical generation of holograms is very difficult, time consuming and the rendering quality is quite unsatisfactory in terms of spatial resolution and definition. Some progress has been achieved in optimizing algorithms for generating CGHs despite of the fact that the research activity on CGH started in the early stage of holography. CGHs are extensively studied because they are the only alternative solution to get a digital hologram from direct optical recording and the subsequent display of a 3D scene. By CGHs it is possible to synthesize holograms of single objects, and also a full scene with multiple objects and in a dynamic way. In any case, this is an extremely difficult task due to the huge needed computation time. Moreover, the results are usually of poor quality in terms of image resolution.

Nevertheless, if one considers the optical holograms, one of the main and not yet resolved problems in recording a dynamic scene of real objects by a laser is strictly connected to the intrinsic properties of such light source. The paradox in holography is that the high directionality and the coherence of the light source constitute the mandatory requirements to record a hologram but at same time both those properties affect severely the recording process. In fact the hologram's quality is strongly dependent from the object's position because of such properties. Those difficulties are common to all type of holograms of real objects independently from the recording medium and the utilized technique.

Surface orientation and texture of the object can also cause problems in recording digital holograms. In fact, depending on the location of the light source and the recording camera, (i.e. the illumination and observation direction, respectively), the scattered light from the object can have such a variation that, for each position of the object, it must be necessary to adjust intensity of the illumination object beam, change the direction of illumination, adjust the exposure time, etc. In fact, it is straightforward to understand that if the object's position changes in the 3D volume, in front of the recording medium, the illuminating laser light strikes the object along different directions for each position. The scattered spectrum (amplitude and phase) is also dependent from the illumination direction, affecting the amount of light that reaches the camera aperture. In addition, the high directivity of laser light produces sharp shadows cones that can hinder the visibility, as a function of object's shape, of some portions of the surface that varies if the position of the object is made change in the image 3D field-of-view. Moreover, speckles size and intensity, recorded by the camera are function of the distance between the object and the recording medium.

Considering for example the same object in a 3D imaged volume, illuminated by the same object laser beam which illuminates the object, but set at two different distances from the camera, one obtains, as the result of the (optical) reconstruction, two images that can have completely different quality of the light intensity of the electro-magnetic waves (utilized to illuminate the object) as a function of the distance and speckles. Consequently, it is important to stress that the optimization of all recording parameters (laser, optical configuration, object surface shape and texture, etc.) in holography is very difficult or even impossible if the aim is to obtain reconstructed images of comparable quality, for both objects. Of course also in photography, or any other imaging technique with white light, there is a dependence from the light conditions and optical configuration. However with coherent light such dependence is much more severe and this, consequently, affects badly the imaging quality. In fact, in white light, it is quite easy to optimize illumination conditions due to the incoherent character of such light. In holography the coherence makes the management of multiple light sources very hard.

More severe is the limit in terms of field-of-view. As it is well known, the pixel size and numerical aperture (NA) of the imaging sensor limits the field of view as a consequence of the right sampling of the spatial frequencies of a hologram (the interferometric fringes).

The above constraint has practical drawbacks that limit the maximum extension of an object or even the range in which, for a fixed optical configuration, an object can be displaced laterally in the 3D scene (the volume in front of the camera) during the recording process.

All the aforementioned problems implies that in practice, in general, holographic recording of a dynamic 3D scene, in which for a example a single object is moved in an ample volume, is not simple, unless an adaptive optical configuration is optimized for each position of the object. But in practice that would be rather impossible.

In the present description, with adaptive optimized optical configuration, it is meant: changing the intensity of object beams illuminating the object as a function of the distance object-detector for optimizing light exposure; changing direction of the illuminating beam to have the appropriate scattering spectrum directionality; changing direction of the reference beam to allow correct sampling on the detector plane.

In recent years, Digital Holography (DH) has revealed its extremely flexibility in 3D imaging, quantitative phase contrast imaging, image recognition, analysis of particle displacements and investigation of microfluidics systems. In biology DH has been extensively applied for various purposes and many original approaches have been proposed and demonstrated too [7-28].

The aforementioned vivacity has stimulated efforts to improve DH on various aspects, such as to improve and control the optical resolution, to define optical set-up and methods for fast and real-time analysis of physical processes, to develop optical configurations with multiple wavelengths, to control and extend the depth of focus, to compensate aberrations, to improve numerical reconstructions [29-36].

Certainly, as discussed above, one of the key attractive feature of DH over other interference microscopy techniques is its intrinsic 3D imaging capability [36-38]. Such attribute gives one the possibilities to explore, by means of numerical diffraction propagation, the volume in front the hologram plane (i.e. the detector plane). Usually, the imaging of objects at different depths is made by numerically reconstructing the holograms on planes that are parallel to the hologram plane but at different distances. However, for objects having 3D extension or 3D shape, only some portions of the object can be in good focus on each of those planes [39-41]. The problem of the limited depth of focus is affecting all optical and imaging systems, even if this paradigm is much more manifested in microscopy, where the need for large magnification has as direct consequence the harshly squeezing of the depth of field.

In classical optical microscopy the problem is solved by scanning mechanically the 3D volume with the aim of extracting “in-focus” information, by a specialized software, from each scanned image plane [42]. By such a procedure it is possible to build-up a single image, named Extended Focus Image (EFI), in which all points of the object are in-focus. In microscopy, however, the problem for objects changing their shape during the measuring time (i.e. for dynamic events) remains unresolved. In this latter case it is not possible to proceed with dynamic scanning acquisition of many images since the mechanical scanning takes a long time, usually minutes.

Among the various approaches proposed in microscopy, there is the use of cubic-phase plates [39]. However various solutions have been proposed by adopting DH [40-44].

Since all the methods in DH are based on a single image acquisition, it is clear that those methods are a factual solution for dynamic objects (i.e. objects that change their shape during the observation time under the microscope).

In one method, by means of DH and use of amplitude and phase numerical reconstruction, it has been demonstrated that an EFI can be built, see for example Patent EP1859408B1 filed on Feb. 23, 2006 in the name of the present Applicant, that is here integrally included by reference.

Nevertheless, since in this latter method the EFI is obtained by the quantitative phase map of the object, in cases where the object has discontinuity in its surface, the above-mentioned method cannot be applied successfully [40]. Different approaches in DH have been based instead on the angular spectrum of plane waves and coordinates rotations for the imaging in all-focus tilted objects. However limitations of those methods lie in the complexity of the numerical computation [40-44].

It is object of the present invention that of providing a holographic method with numerical reconstruction permitting overcoming the drawbacks and solving the problems of the prior art.

It is further object of the present invention that of providing apparatuses and instruments necessary for carrying out the method according to the invention.

Furthermore, it is specific object of the present invention a holographic apparatus employing the method according to the invention.

It is subject-matter of the present invention a method for the reconstruction of holographic images in Digital Holography, comprising the following steps:
A hologram of an investigated object is detected and recorded at a distance d from it, by a detection device that is constituted by an integrated array of image detection elements, that spatially sample the hologram with a number N of pixels along the x-axis of the hologram plane, each having length Δx, and a number M of pixels along the y-axis of the hologram plane, each having length Δy, thus obtaining a rectangular array of a number Vᵣ=N·M of values proportional to light intensity values of the hologram, such a rectangular array being called a “digital hologram” h(x,y);
Starting from the digital hologram, the same hologram, or a portion of it corresponding e.g. to an object image, is reconstructed in the reconstruction plane, at a distance D from the hologram plane, using the usual diffraction Fresnel propagation integral, i.e. discrete Fresnel transform;

The method being characterised in that, if one chooses that D≠d, the reconstruction of the hologram comprises the following sub-steps:
A. A geometric transformation, realized by introducing pixels having intensity values that are interpolated between the adjacent ones, is applied to the recorded digital hologram h(x,y), or a portion thereof, to obtain a transformed digital hologram h(x′,y′);
B. The discrete Fresnel Transform is performed on the transformed digital hologram h(x′,y′) or portion thereof to obtain the reconstructed digital hologram at distance D.

Preferably according to the invention, the transformed digital hologram h(x′,y′) is obtained by a polynomial transformation of the coordinates x′=Polₙ(x,y), y′=Pol′ₙ(x,y) where Polₙ(x,y), Pol′ₙ(x,y) is a polynomial of order n.

Preferably according to the invention, Polₙ(x,y) is a polynomial of order 2, i.e. a parabolic function.

Preferably according to the invention, Polₙ(x,y) is a polynomial of order 1, i.e. a linear function, in particular y′=αy and x′=αx, thus obtaining that D=α²d, with α that is a real number.

Preferably according to the invention, different portions of a digital hologram undergo step A for different reconstruction distances D, each portion being deformed by means of a specific transformation function, so as to obtain a final hologram image wherein said different portions are all in focus.

It is further specific subject-matter of the present invention a method for the reconstruction of holographic images in Digital Holography, comprising the following steps:
A hologram of an investigated object is detected and recorded at a distance d from it, by a detection device that is constituted by an integrated array of image detection elements, that spatially sample the hologram with a number N of pixels along the x-axis of the hologram plane, each having length Δx, and a number M of pixels along the y-axis of the hologram plane, each having length Δy, thus obtaining a rectangular array of a number Vᵣ=N·M of values proportional to light intensity values of the hologram, such a rectangular array being called a “digital hologram” h(x,y);
Starting from the digital hologram, the same hologram, or a portion of it corresponding e.g. to an object image, is reconstructed in the reconstruction plane, at a distance D from the hologram plane, using the usual diffraction Fresnel propagation integral, i.e. discrete Fresnel transform;
   The method being characterised in that, if one chooses that D≠d, the reconstruction of the hologram comprises the following sub-steps:
A. A geometric transformation, realized by introducing pixels having intensity values that are interpolated between the adjacent ones, is applied to the recorded digital hologram h(x,y), or a portion thereof, to obtain transformed digital holograms h(x′,y′);
B. The transformed digital holograms h(x′,y′) are projected onto a SLM optic reconstruction device, so as to obtain their subsequent visualization as forward and/or backward move along the optical axis, thus creating a dynamical three-dimensional scene.

Preferably according to the invention, step A is performed in parallel for several different digital holograms h(x,y) of a different position of an object with respect to the detection device, and the results are composed in an only whole digital hologram, so as to obtain the effect of different portions of said whole hologram being moved back and/or forth along the optical axis and turned around themselves, thus creating a dynamical 3D scene.

It is further specific subject-matter of the present invention a method for the reconstruction of holographic images in Digital Holography, comprising the following steps:
A hologram of an investigated object is detected and recorded at a distance d from it, by a detection device that is constituted by an integrated array of image detection elements, that spatially sample the hologram with a number N of pixels along the x-axis of the hologram plane, each having length Δx, and a number M of pixels along the y-axis of the hologram plane, each having length Δy, thus obtaining a rectangular array of a number Vᵣ=N·M of values proportional to light intensity values of the hologram, such a rectangular array being called a “digital hologram” h(x,y);
Starting from the digital hologram, the same hologram, or a portion of it corresponding e.g. to an object image, is reconstructed in the reconstruction plane, using the usual discrete Fourier transform of the diffraction;
   The method being characterised in that, when the object is tilted with respect to the hologram plane, and the points of its surface are at a distance D=2αdl′, wherein l′ represents the coordinate along the slope of the object tilted with respect to the hologram plane, the reconstruction of the hologram comprises the following steps:
A. a deformation f(x)=x+αx², with a an arbitrary real number, is applied to the recorded digital hologram h(x,y) or a portion thereof, the deformation being realized by introducing pixels having intensity values interpolated between the adjacent ones, to obtain a transformed digital hologram h(x′,y′);
B. the discrete Fourier transformation is performer on the transformed digital hologram h(x′,y′) or a portion thereof in order to obtain the reconstructed digital hologram for all the points of said inclined surface that find themselves at the distance D=2αdl′, thus obtaining all the points of said surface simultaneously in focus. Preferably according to the invention:
step A is performed for several holograms detected by different light wavelengths, thus appearing with different pixel's size, to obtain the same size for the holograms, i.e. the same reconstruction distance D,
   The holograms so reconstructed being superposed, thus obtaining an in-focus color Digital Holography image. It is further specific subject-matter of the present invention a computer program characterised in that it comprises code means apt to execute, when running on a computer, the method according to the invention.

It is further specific subject-matter of the present invention a memory medium, readable by a computer, storing a program, characterised in that the program is the computer program according to the invention.

It is further specific subject-matter of the present invention an apparatus for detection of holographic images, comprising an integrated array of image detection devices and a digitized hologram processing unit, characterised in that the processing unit processes the data detected by said a detection device by using the method according to the invention.

The present invention will be now described, for illustrative but not limitative purposes, according to its preferred embodiments, with particular reference to the figures of the enclosed drawings, wherein:

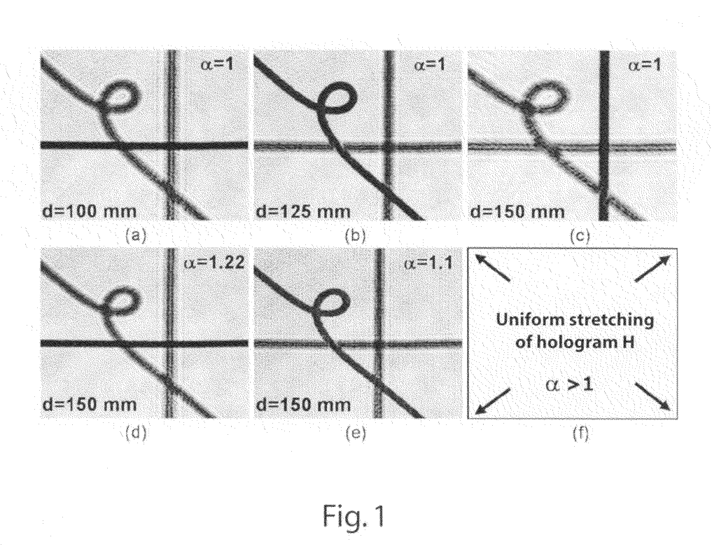

FIG. 1 shows a reconstruction of a digital hologram as recorded (no-stretching) at three different distances with each wire in focus at distance of (a) 100 mm, (b) 125 mm and (c) 150 mm, respectively; when the holograms is stretched according to the invention with □=1.1 the horizontal wire is in focus at distance of d=150 mm (d) while for □=1.22 the curved wire is in focus even at d=150 mm (e); in (f) the conceptual draw of the stretching of H.

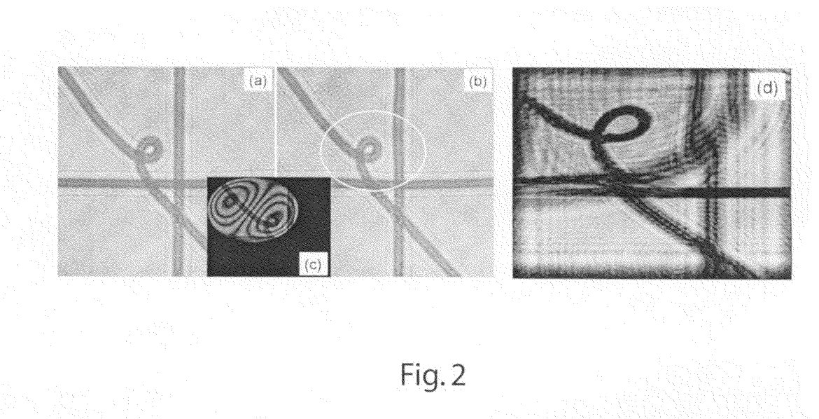

FIG. 2 shows a reconstruction of a digital hologram with local deformation applied to twisted-wire's eyelet: (a) holograms as recorded (no-stretching); (b) deformed hologram according to the invention; (c) Moiré beating between the two holograms to put in evidence the local deformation. Numerical reconstruction at d=100 mm of hologram in (b) in which the horizontal wire and the eyelet are in focus. Some distortions are clearly present in the reconstruction.

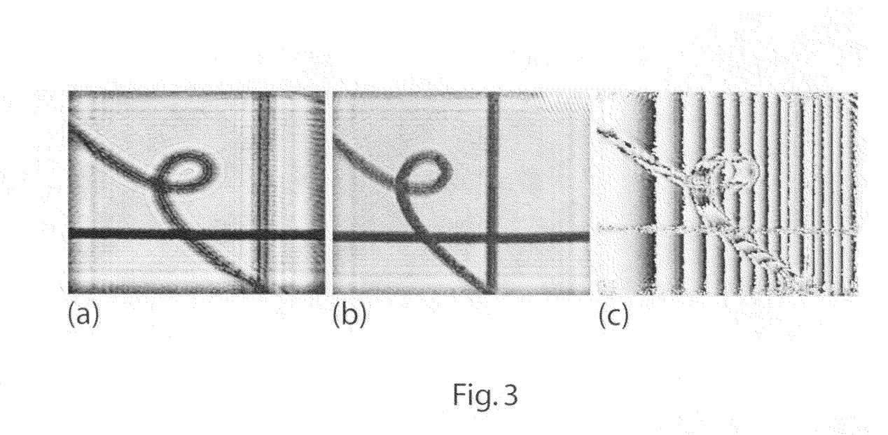

FIG. 3 shows (a) a reconstruction at d=100 mm for the original hologram; (b) reconstruction of the adaptively deformed hologram according to the invention with quadratic deformation (cylindrical) such that two orthogonal wires result to be both in-focus while the twisted wire appears in focus only in a single point as it would be along a tilted plane; (c) phase difference between the two holograms calculated at d=100 mm showing parabolic wrapped phase;

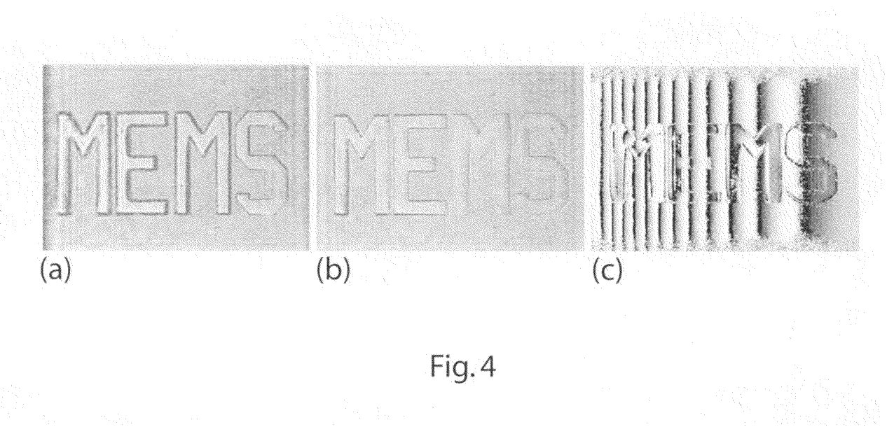

FIG. 4 shows a quadratic adaptive deformation applied according to the invention along the x-axis to an hologram of a tilted object: (a) reconstruction of the recorded hologram, as recorded, showing the tilted focus aberration; (b) reconstruction of the adaptively deformed hologram according to the invention in which the all letters appear in-focus, reconstruction of the original digital hologram; (c) phase-difference showing the removal of focus tilted aberration;

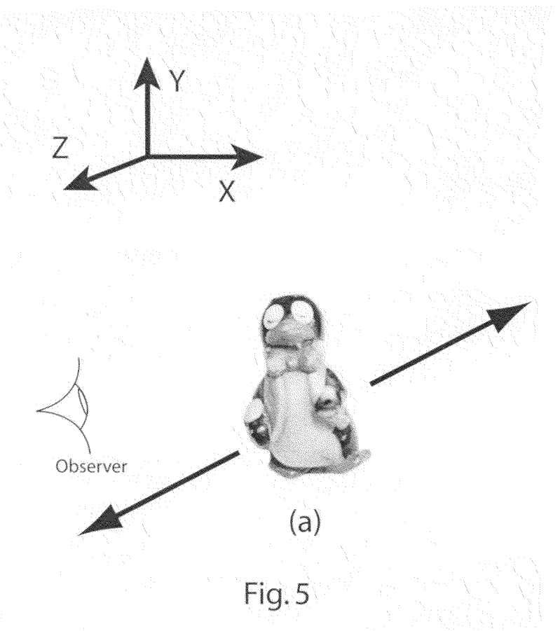

FIG. 5 shows a 3D scene in which a single object (Parrot puppet) is moved back-and-forth, according to the invention;

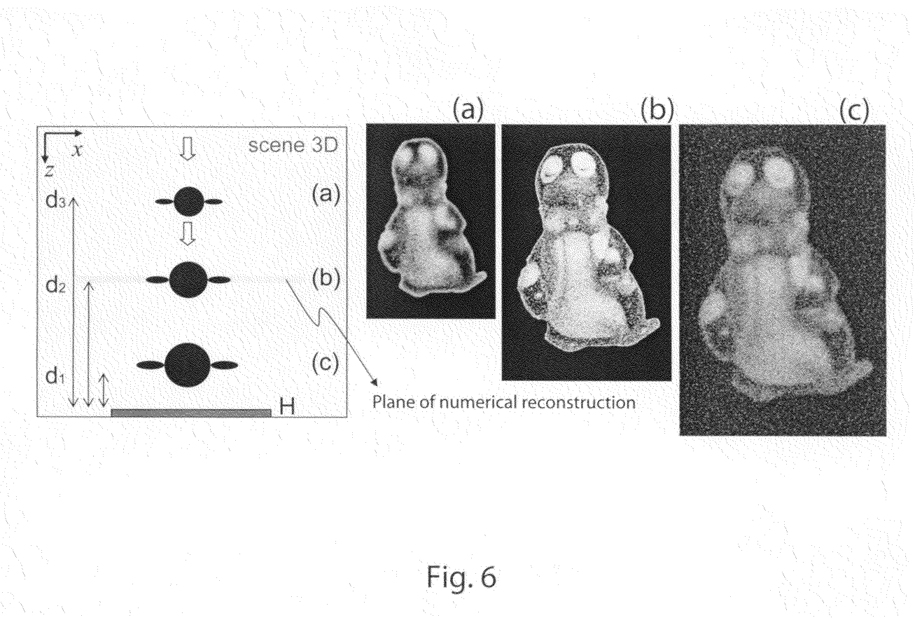

FIG. 6 shows the numerical reconstruction of an object (Parrot puppet) at three different distances (d₁=22 mm, d₂=33 mm, d₃=44 mm) respectively, according to the invention;

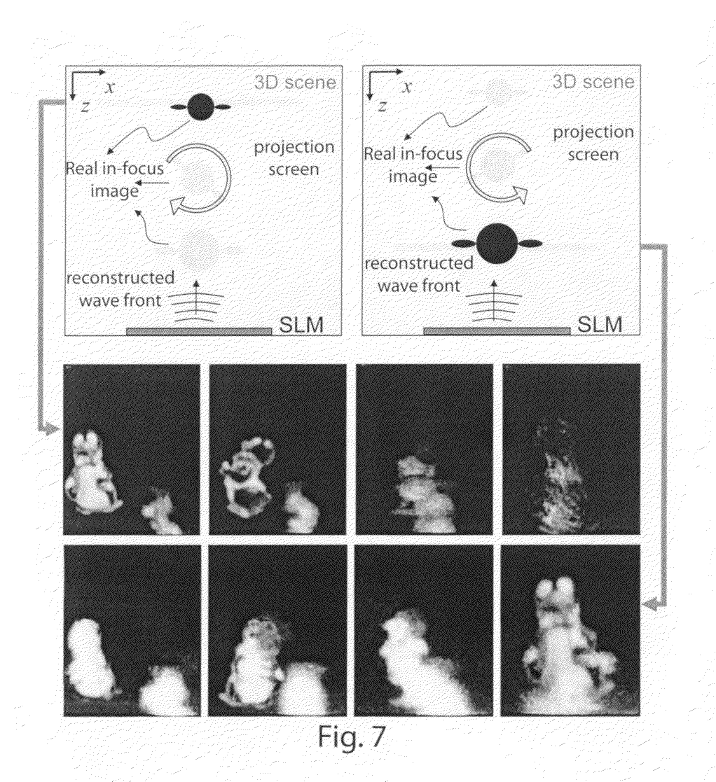

FIG. 7 shows a sequence of pictures of the real images obtained by the optical reconstruction by a LCOS device collected on a screen at various distances of 22 mm, 33 mm, and 44 mm, respectively;

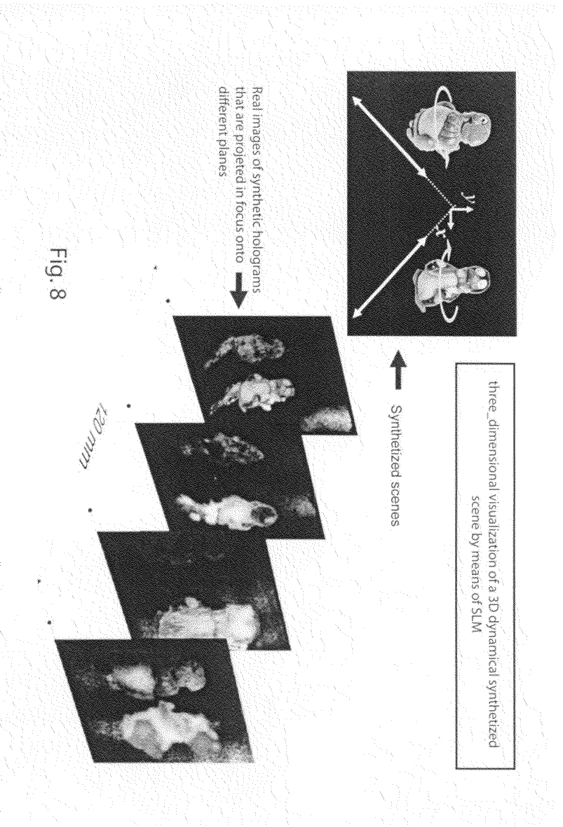

FIG. 8 shows the reconstruction of two digital holograms of “Puppet” and “Penguin” combined together in different dynamic 3D scenes, according to the invention;

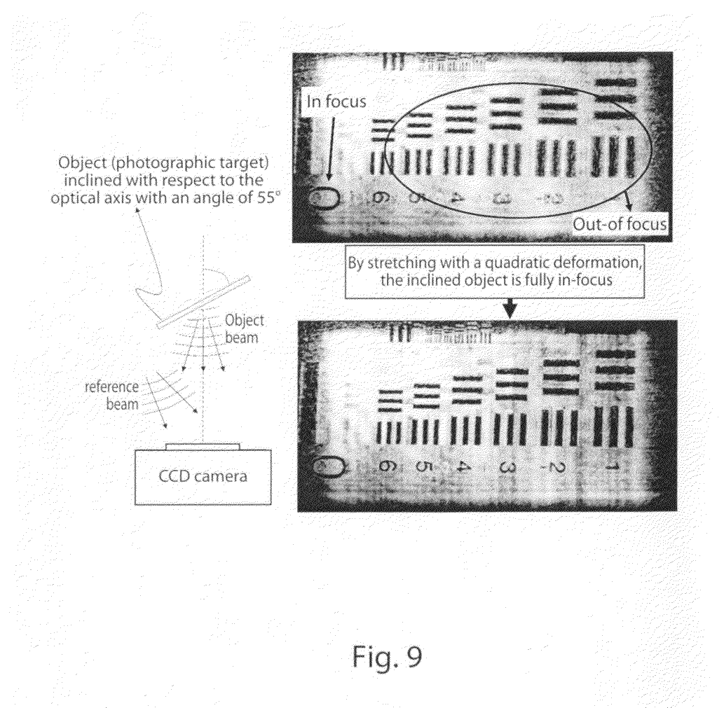

FIG. 9 shows the reconstruction of a tilted object, according to the invention.

To overcome all the above-mentioned difficulties, it is here proposed an original method that consists in building-up and making in action a synthetic 3D scene with a process that is analogous to that of cartoons. However, in this case the movie has the challenging attribute to be displayed and observed in 3D. The method is possible thanks to an innovative way to process the digital holograms, that has never been implemented before.

Consider a digital hologram of a single object recorded at distance d. The numerical reconstruction of the object in focus is obtained numerically at distance d from the hologram plane by adopting the well known numerical modeling and computing of the diffraction Fresnel propagation integral, given by

$$b ( x , y ) = \frac{1}{i λ d} {\int }_{ }^{ } {\int }_{ }^{ } h ( ξ , η ) r ( ξ , η ) {e}^{i k d [ 1 + \frac{{( x - ξ )}^{2}}{2 {d}^{2}} + \frac{{( y - η )}^{2}}{2 {d}^{2}} ]} d ξ d η \qquad ( 1 )$$

Wherein h(x,y) and r(x,y)=1 (reference beam is generally a collimated plane wave-front) are the hologram and reference beam respectively. If an affine geometric transformation is applied to the original recorded hologram, consisting in a simple stretching and described by [ξ′η′]=[ξη1]T through the operator

$$T = [ \begin{matrix}a & 0 \\ 0 & a \\ 0 & 0\end{matrix} ] ,$$

one obtains the transformed hologram h(ξ′,η′)=h(αξ,αη). Consequently, the propagation integral changes in:

$$\begin{matrix}B ( x , y , d ) = \frac{1}{iλ d} {e}^{i k d} {\int }_{ }^{ } {\int }_{ }^{ } h ( αξ , αη ) \\ {e}^{\frac{i k {{α}^{2} ( x - ξ )}^{2}}{2 d {α}^{2}}} {e}^{\frac{i k {{α}^{2} ( y - η )}^{2}}{2 d {α}^{2}}} d ξ d η = \\ = \frac{1}{{iα}^{2} λ d} {e}^{i k d} {\int }_{ }^{ } {\int }_{ }^{ } h ( {ξ}^{′} , {η}^{′} ) \\ {e}^{\frac{i k {( {x}^{′} - {ξ}^{′} )}^{2}}{2 D}} {e}^{\frac{i k {( {y}^{′} - {η}^{′} )}^{2}}{2 D}} d {ξ}^{′} d {η}^{′} \\ = \frac{1}{{α}^{2}} b ( {x}^{′} , {y}^{′} , D )\end{matrix} \qquad ( 2 )$$

Such simple stretching applied to the hologram has very interesting impact on the numerical or even optical reconstructions. In fact from equation (2) it is clear that the new hologram reconstructs the object in focus at a different distance D=α²d while x′=αx and y′=αy, wherein the hologram has been simple stretched and α is the elongation factor.

To show the impact that the stretching has on numerical reconstructions, different experiments have been performed whose results are reported in FIG. 1. The object was made of three different wires positioned at different distances from the CCD array. The optical configuration was in off-axis mode and with a plane reference beam wave-front (r(x,y)=1). The three wires were positioned at different distances from the CCD. They had a diameter of 120 μm. The horizontal wire, the twisted wire with the eyelet and the vertical wire were set at distances of 100 mm, 125 mm and 150 mm, respectively. The numerical reconstructions at the above distances give an image in which each wire at a time is in good focus, as shown in FIGS. 1a, 1b and 1c, at the corresponding recording distances.

When the hologram h(x,y) is uniformly stretched with an elongation factor along both dimensions (x,y) of α=1.22, the horizontal wire results to be in focus at different distance of d=150 mm (FIG. 1d) instead of 100 mm. If α=1.1, the twisted wire with the eyelet is in focus at d=150 mm (FIG. 1e) instead that at d=125 mm. Anyway, the results shown in FIG. 1 demonstrate that the depth of focus can be controlled by means of the uniform stretching of the holograms according to Eq. (2). In case of □<1 the objects results to be at shorter distance in respect to the real distance.

More in general, the range of α is preferably 0.5-2, more preferably 0.7-1.7.

This interesting result implies that by opportune and adaptive deformation of digital holograms different parts of the 3D scene that are at different depths can be obtained in good focus in a single reconstruction as will be demonstrated below. In fact the next logical step was to understand how to deform an hologram for having in focus in the same reconstruction plane different objects lying at different distance from the hologram plane (i.e. CCD sensor), but falling in the same field of view. In this case, the deformation has to be adapted to the various situations being no longer uniform. If one considers, in general, a polynomial deformation of the form

[ξ′η′]=[ξηξ*ηξ²η²]T

can be adapted to the various situations. In the case of the present invention, a quadratic deformation has been adopted such that the operator T this time is expressed by

$$T = [ \begin{matrix}0 & 0 \\ 1 & 0 \\ 0 & 1 \\ 0 & 0 \\ β & 0 \\ 0 & γ\end{matrix} ] .$$

This time the deformation has been applied only to a portion of the entire holograms. In FIGS. 2a and 2b the original recorded hologram and the holograms obtained with the adaptive deformation are shown. The quadratic deformation is very slight and it has been applied only to the region inside the white ellipse in FIG. 2b. The deformation is so small that it is difficult to note the difference between the two holograms with the naked eye. To visualize the deformation, in FIG. 2c, the beating (moiré) effect by plotting the image given by the function |h−h_{def}| is shown.

One used values for β and □ such that the equivalent average shrinkage in the central part was □=0.85 that allows to put in focus the wire with the eyelet at the distance of d=100 mm. In FIG. 1c it is clear that the hologram is unchanged (black area) everywhere except that in the region where it was applied the adaptive deformation. The shrinkage of the hologram in that area has as effect of moving forward the eyelet that is now in focus. In fact in FIG. 2d the reconstruction at d=100 mm is shown where the horizontal wire in good focus together with the eyelet of the wire are clearly visible. Apart from the obvious distortions in the neighbors, the result shown in FIG. 2d demonstrates that two portions of the objects, falling inside the field of view of the same hologram, but at different distances, can be obtained in-focus in the same reconstructed image plane thanks to the opportune deformation applied to the hologram.

More in general, the range of β or γ is preferably 10⁻⁵-10⁻², more preferably 10⁻⁴-5×10⁻³.

One more example is displayed in FIG. 3. In this case the aim of the adaptive deformation is to have in focus in a single image plane the two straight wire (i.e. horizontal and vertical wire). This time, a different deformation has been applied with quadratic deformation only along the horizontal direction (i.e.

$$T = [ \begin{matrix}0 & 0 \\ 1 & 0 \\ 0 & 1 \\ 0 & 0 \\ β & 0 \\ 0 & 0\end{matrix} ]$$

with β=0.0002). When a distortion is applied only along x-axis (anamorphic deformation), of course, it is straightforward to understand that the focus of the horizontal wire is not affected. On the contrary, the diffraction pattern of the vertical wire in the hologram is magnified by the cylindrical deformation. In FIG. 3a the reconstruction at d=100 mm is shown again, showing the horizontal wire in focus for an undistorted hologram while the other two are clearly out-of-focus. In FIG. 3b the reconstruction of the deformed hologram with cylindrical deformation is shown, wherein both the vertical and the horizontal wires are in-focus when such deformed hologram is still reconstructed at very same distance of d=100 mm. It is important to note that the twisted wire experiences different degrees of defocus in the image plane at d=100 mm of the deformed hologram. In fact, it clear that the quadratic deformation has caused different focus variation in different portions of the hologram. Essentially one can say here that for each portion of the hologram the focus was changed in different way. In fact the phase variation in the map has a parabolic shape indicating that the focus has been changed in different regions of the hologram following a cylindrical curvature. For illustrative purpose it is reported in FIG. 3c that phase map obtained by the subtraction of the two holograms: the not-deformed and the deformed hologram. It is clear that each portion of the hologram has been stretched differently. Since the quadratic deformation is very small, one can approximate it to linear deformation for each small portion of the hologram. In this way, one can consider the deformation produces a variable focus change.

As final demonstration, one shows here one further case in which one was able to recover the EFI image for a tilted object in microscope configuration. The object is a silicon wafer with letters “MEMS” written on it. The object was tilted with an angle of 45° with respect to the optical axis of the DH system. The details about the recording of the hologram are reported in detail in ref.[41]. In this case, a quadratic deformation has been applied on the entire hologram. The deformation was applied only along the x-axis with a value of β=0.00005. The quadratic deformation has allowed to get an EFI image of the tilted object as shown in FIG. 4. In FIG. 4a the reconstruction of the undistorted hologram at distance of d=265 mm is shown. It is important to note that while the portion of the object with letter “S” in focus, the rest is gradually out-of-focus, due to inclination angle of the object. In FIG. 4b the reconstruction obtained on the quadratic deformed hologram is shown and this shows that now all the letters “MEMS” are in good focus. The results of FIG. 4b demonstrates the EFI is obtained by an adaptive deformation of the hologram. In FIG. 4c also the phase-map difference is shown, which is calculated by subtracting the two holograms the deformed and the original one. The phase map indicates that the defocus tilt between the two holograms has been mainly removed by the deformation.

Based on this simple principle, one can play with a digital hologram by creating a 3D scene in which a single object is moved back-and-forth as shown in FIG. 5. Since the hologram can be geometrically transformed and numerically adapted to change the distance at which it will appear in focus in the reconstruction process an observer will see a 3D scene either in the numerical as well as in the optical reconstruction by a SLM device. A sequence of digital hologram with different elongation factor a will be successively reconstructed with this aim.

In FIG. 6 the numerical reconstruction Parrot is shown at three different distances (d1, d2, d3) respectively. “Parrot” puppet appears to be in focus only at distance d2 while the effect of the stretching with different elongation factors moves it out of focus, i.e. the puppet is moved forward or backward.

In FIG. 7 a sequence of pictures of the real images is instead shown as obtained by the optical reconstruction by a LCOS device collected on a screen at various distances where an observer will see Parrot to go back and forth in the 3D volume with very huge depth of focus (over 120 mm) thanks to this simple but effective adaptive transformation of its digital hologram. In fact, in FIG. 7 the 3D scene that has been synthesized is depicted, wherein “Parrot” travels inward and outward in the 3D volume while it is composing a pirouette.

In other words, the geometric transformation can be flexible and adapted to manipulate the object's position, size in 3D and within a very large depth of filed, thus eliminating the need of recording holograms in many positions at different distances from the camera.

The animated and more complex 3D scene shown in FIG. 7 has been synthetically constructed by using different holograms. The procedure is based on recording several digital holograms of single objects while the object rotates of 360° angle around its vertical axis but in a fixed position. The recording process is performed with an optimized optical configuration that allows to get high quality hologram. Each single hologram can be geometrically transformed and numerically adapted for constructing a 3D scene.

The advantage of this synthetic procedure is that this more complex 3D scene can be displayed by using holograms recorded all in the very same condition and hence with same quality. One uses each digital hologram as single frame of the dynamic action in analogy with cartoons where each different drawing is used as single frame in the movie.

The important fact in our approach is that, in order to move the object in 3D, it is not necessary to record hologram of the object in different positions, movement that instead is in our case obtained by an adaptive transformation of the digital hologram. One could say that each stored hologram is a single brick to build-up the 3D scene with high flexibility. The dynamic effect is obtained by reconstructing sequentially the various digital holograms that are geometrically transformed according to the dynamic design of the 3D scene. This approach has valuable implications in 3D holographic display, because, by means of a data-base of digital holograms of an object recorded in a fixed position and under optical optimized conditions, a 3D scene can be synthesized and put in action and displayed in 3D.

By this novel approach of the invention, it is possible to overcome the problem of optimizing the recording optical set-up for each position of the object in the 3D volume. In fact, the quality of the hologram of the object is strongly dependent on the object's position as above explained.

The approach of the present invention is alternative to the much more complex one that is based on CGHs to synthesize 3D objects and scenes. However, the approach of the present invention can be defined as an hybrid because one is able to overcome the poor quality of CGH since optical holograms of real objects are recorded. Moreover, the method according to the invention allows to combine easily and in flexible way two or more digital holograms (coming from real objects or generated by computer) in an only 3D scene to be displayed.

Therefore, in a sentence, one can say that one benefits from the highest quality of optical holograms with respect to CGH while, thanks to the intrinsic digital nature of the holograms, one uses numerical computation to use, synthesize and put in action dynamic holographic 3D scenes displayable in 3D by a SLM. The method according to the invention can be applied in any holographic configuration where digital holograms are available.

Based on the foregoing, it is possible to synthesize a 3D scene by combining, coherently, various digital holograms. This overcomes a further, above-discussed concerning the limited field-of-view. By means of spatial multiplexing of various digital holograms, it is possible to construct even more complex and dynamic 3D scene with more than one object.

In FIG. 8, the reconstruction of two digital holograms of “Parrot” and “Penguin”, combined together in different dynamic 3D scenes, are shown. The two holograms were recorded separately and with the two puppies at the very same distance and optical conditions. By using the two basic original holograms and stretching them separately before combining them, one shows here it is possible to synthesize a 3D scene with more than one objects. In FIG. 8, 3D projected real images (different frames of a movie (not enclosed)) are in fact shown, in which the two puppies “Parrot” and “Penguin” travel back and forth both making pirouettes.

The quadratic deformation allows, in particular, to obtain Extended Focus Images (EFI) of tilted objects in the case of “Fourier-type” holograms. “Fourier-type” holograms are a special class of holograms in which the reference beam has the same curvature of the object beam. The numerical reconstruction of “Fourier-type” hologram is obtained by means of the Fourier transform of the hologram instead of the Fresnel diffraction integral [45].

Indeed, by using the Fourier Transform property for composite function:

h(x)=g(f(x))=∫G(l)e^{i2πl/·f(x)}dl

Wherein G(l) is the Fourier Transform of g(y), one has

ĥ(k)=∫e^{-2πk·x}∫G(l)e^{i2πl·f(x)}dldx

ĥ(k)=∫G(l)P(k,l)dl

Wherein

P(k,l)=∫e^{-i2πk·x}e^{i2πl·f(x)}dx

For quadratic coordinate transformation one has that f(x)=x+αx², therefore it results that:

$$P ( k , l ) = \sqrt{\frac{π}{2 π al}} {e}^{{iπ}^{2} \frac{{( k - l )}^{2}}{2 π al} {e}^{i \frac{π}{4}}}$$

$$Therefore \text{:}$$

$$\hat{h} ( k ) = {\int }_{ }^{ } G ( l ) P ( k , l ) d l = {e}^{i \frac{π}{4}} {\int }_{ }^{ } G ( l ) \sqrt{\frac{1}{2 al}} {e}^{2 π \frac{{( k - l )}^{2}}{4 al}} d l$$

Where ĥ(k) is the obtained reconstruction, while G(l) is the reconstruction of the initial hologram.

### If

$$k = \frac{{k}^{′}}{λ d} and l = \frac{{l}^{′}}{λ d} then {e}^{2 π \frac{{( k - l )}^{2}}{4 al}} = {e}^{\frac{2 π}{λ} \frac{{( {k}^{′} - {l}^{′} )}^{2}}{2 D}}$$

Wherein D=2dαl′.

Therefore, the final reconstruction is approximately like the reconstruction of the initial hologram propagated to a distance D that depends linearly on the coordinate.

Experimental verification of this invention effect can be seen on FIG. 9.

It is important to note that for the special class of “Fourier-type” holograms, a linear deformation (i.e. elongation or stretching) does not produce any change of focus in the reconstruction. In fact, starting from the hologram:

h(ξ,η)=f(u,v)=f(αξ,αη)

Because of the Fourier transform properties, one has that

$$\hat{h} ( x , y ) = \frac{1}{a} \hat{f} ( \frac{x}{a} , \frac{y}{a} )$$

wherein ĥ(x,y) is the new reconstruction and comes out to be the reconstruction of the initial hologram with the scaled dimension (and a scaled intensity). There is no change in the reconstruction distance and therefore in the reconstruction focus. However, as above demonstrated, a polynomial deformation of second order (quadratic) is able to put all the objects in focus which are tilted with respect to the optical axis (see FIG. 9). Moreover, the method presented in this invention can be also useful for superimposing correctly reconstructed images obtained by the Fresnel-diffraction formula of digital holograms recorded with different wavelengths. In fact in “colour-holography” more than one (usually 3 ones to obtain RGB colour images) digital hologram of the same object or scene are recorded with different wavelengths. If eq. (1) is used for reconstructing such holograms, then the object reconstructed with different wavelengths (colours) appears to have different sizes (in fact it is well known that the reconstruction pixel, using eq. (1), depends form the numerical value of the wavelength). The methods described in the present invention can allow to get reconstructed images having instead the same size so that the reconstructed images for each wavelength (either numerical or optical) can be perfectly superimposed with the aim of displaying correct colour 3D holographic images.

In conclusion, one has shown that, by means of the holograms adaptive deformation, it is possible to control the focus depth in many situations. The procedure is very easy to apply and it can be very useful in many situations where the focus of the entire field of view or even some portions of it have to be controlled. This novel method will open more potentialities in the 3D imaging and microscopy in coherent light by DH and in 3D holography display.

### BIBLIOGRAPHY

1. Gabor. D. (1948). “A new microscopic principle” Nature, 161:777{778}
2. Tay S. et al. An updatable holographic three-dimensional display Nature 451, 694-698 (7 Feb. 2008)
3. Benton, S. A. Selected Papers on Three-Dimensional Displays (SPIE Optical Engineering Press, Bellingham, Wash., 2001)
4. Lessard, L. A. & Bjelkhagen, H. I. (eds) Practical Holography XXI: Materials and Applications (Special Issue) Proc. SPIE 6488, (2007)
5. Meerholz, K. & Volodin, B. L. Sandalphon, Kippelen, B. & Peyghambarian, N. Photorefractive polymer with high optical gain and diffraction efficiency near 100%. Nature 357, 479-500 (1994)
6. Marder, S. R., Kippelen, B., Jen, A. K.-Y. & Peyghambarian, N. Design and synthesis of chromophores and polymers for electro-optic and photorefractive applications. Nature 388, 845-851 (1997)|Article|ChemPort|
7. Chatterjee, M. R. & Chen, S. Digital Holography and Three-Dimensional Display: Principles and Applications (ed. Poon, T.) Ch. 13 379-425 (Springer, New York, 2006)
8. Iizuka, K. Welcome to the wonderful world of 3D: introduction, principles and history. Optics Photonics News 17, 42-51 (2006)|Article|
9. Dodgson, N. A. Autostereoscopic 3D displays. Computer 38, 31-36 (2005)|Article|
10. Favalora, G. E. Volumetric 3D displays and application infrastructure. Computer 38, 37-44 (2005)|Article|
11. Downing, E., Hesselink, L., Ralston, J. & Macfarlane, R. A. Three-color, solid-state, three-dimensional display. Science 273, 1185-1189 (1996) Article|ChemPort|
12. Thayn, J. R., Ghrayeb, J. & Hopper, D. G. 3-D display design concept for cockpit and mission crewstations. Proc. SPIE 3690, 180-186 (1999)
13. Choi, K., Kim, J., Lim, Y. & Lee, B. Full parallax, viewing-angle enhanced computer-generated holographic 3D display system using integral lens array. Opt. Exp. 13, 10494-10502 (2005)
14. Miyazaki, D., Shiba, K., Sotsuka, K. & Matsushita, K. Volumetric display system based on three-dimensional scanning of inclined optical image. Opt. Exp. 14, 12760-12769 (2006)
15. St, Hilaire, P., Lucente, M. & Benton, S. A. Synthetic aperture holography: a novel approach to three dimensional displays. J. Opt. Soc. Am. A 9, 1969-1978 (1992)
16. Huebschman, M. L., Munjuluri, B. & Garner, H. R. Dynamic holographic 3-D image projection. Opt. Exp. 11, 437-445 (2003)
17. Halle, M. W. Holographic stereograms as discrete imaging systems. Proc. SPIE 2176, 73-84 (1994)
18. Benton, S. A. Survey of holographic stereograms. Proc. SPIE 367, 15-19 (1983)
19. Leith E and Upatnieks J. (1965). “Microscopy by wavefront reconstruction.”, J. Opt. Soc. Am., 55:569-570.
20. Goodman J W and Lawrence R W. (1967), “Digital image formation from electronically detected holograms.” Appl. Phy. Lett., 11:77{79}.
21. Kronrod R W, Merzlyakov N S, and Yaroslayskii L P. (1972). “Reconstruction of a hologram with a computer.” Sov. Phys. Tech. Phys., 17:333-334.
22. Schnars U. (1994). “Direct phase determination in hologram interferometry with use of digitally recorded holograms.” J. Opt. Soc. Am. A., 11:2011-2015
23. Schanrs U and Juptner W. (1994). “Direct recording of holograms by a CCDTarget and numerical reconstruction.” Appl. Opt., 33:179-181
24. Kreis T M and Juptner W. (1997). Principles of Digital Holography. In: Juptner, Osten, ed. Fringe 97, Academic, Verlag, pp. 253-363.
25. “Digital Holography and Three-Dimensional Display, Principles and Applications” T.-C. Poon ed., (Springer, 2006).
26. V. Micó, J. Garcia, Z. Zalevsky, and B. Javidi, “Phase-shifting Gabor holography,” Opt. Lett. 34, 1492-1494 (2009)
27. Q. Weijuan, Y. Yingjie, C. O. Choo, and A. Asundi, “Digital holographic microscopy with physical phase compensation,” Opt. Lett. 34, 1276-1278 (2009)
28. T. Kim, Y. S. Kim, W. S. Kim, and T.-C. Poon, “Algorithm for converting full-parallax holograms to horizontal-parallax-only holograms,” Opt. Lett. 34, 1231-1233 (2009)
29. M. Kanka, R. Riesenberg, and H. J. Kreuzer, “Reconstruction of high-resolution holographic microscopic images,” Opt. Lett. 34, 1162-1164 (2009)
30. D. Wang, J. Zhao, F. Zhang, G. Pedrini, and Wolfgang Osten, “High-fidelity numerical realization of multiple-step Fresnel propagation for the reconstruction of digital holograms”, Appl. Opt. 47, D12-D20 (2008)
31. Y. Seok Hwang, S.-H. Hong, and B. Javidi, “Free View 3-D Visualization of Occluded Objects by Using Computational Synthetic Aperture Integral Imaging,” J. Display Technol. 3, 64-70 (2007)
32. Y. Takaki and H. Ohzu, “Hybrid holographic microscopy: visualization of three-dimensional object information by use of viewing angles”, Appl. Opt. 39, 5302-5308 (2000)
33. E. Malkiel, J. N. Abras and J. Katz, “Automated scanning and measurements of particle distributions within a holographic reconstructed volume”, Meas. Sci. Technol. 15, 601-612(2004).
34. P. Ferraro, G. Coppola, S. De Nicola, A. Finizio, G. Pierattini, “Digital holographic microscope with automatic focus tracking by detecting sample displacement in real time,” Opt. Lett. 28, 1257-1259 (2003)
35. M. Antkowiak, N. Callens, C. Yourassowsky, and F. Dubois, “Extended focused imaging of a microparticle field with digital holographic microscopy,” Opt. Lett. 33, 1626-1628 (2008)
36. F. Dubois, C. Schockaert, N. Callens, and C. Yourassowsky, “Focus plane detection criteria in digital holography microscopy by amplitude analysis,” Opt. Express 14, 5895-5908 (2006)
37. M. Liebling and M. Unser, “Autofocus for digital Fresnel holograms by use of a Fresnelet sparsity criterion,” J. Opt. Soc. Am. A 21, 2424-2430 (2004).
38. R. J. Pieper and A. Korpel, “Image processing for extended depth of field,” Appl. Opt. 22, 1449-1453 (1983).
39. R. Edward, Jr. Dowski, W. T. Cathey, “Extended depth of field through wavefront coding” Appl. Opt. 34, 1859-1866 (1995).
40. P. Ferraro, S. Grilli, D. Alfieri, S. De Nicola, A. Finizio, G. Pierattini, B. Javidi, G. Coppola, e V. Striano, “Extended focused image in microscopy by digital Holography,” Opt. Express 13, 6738-6749 (2005)
41. S. De Nicola, A. Finizio, G. Pierattini, P. Ferraro, and D. Alfieri, “Angular spectrum method with correction of anamorphism for numerical reconstruction of digital holograms on tilted planes”, Opt. Express 13, 9935-9940 (2005)
42. S. J. Jeong and C. K. Hong, “Pixel-size-maintained image reconstruction of digital holograms on arbitrarily tilted planes by the angular spectrum method”, Appl. Opt. 47, 3064-3071 (2008)
43. K. Matsushima, “Formulation of the rotational transformation of wave fields and their application to digital holography,” Appl. Opt. 47, D110-D116 (2008)44.C. P. McElhinney, B. M. Hennelly, and T. J. Naughton, “Extended focused imaging for digital holograms of macroscopic three-dimensional objects,” Appl. Opt. 47, D71-D79 (2008)
45. P. Hariharan, “Basics of Holography”, University of Sydney, ISBN-13: 9780511074899 I ISBN-10: 0511074891, CAMBRIDGE UNIVERSITY PRESS.

The present invention has been described for illustrative but not limitative purposes, according to its preferred embodiments, but it is to be understood that modifications and/or changes can be introduced by those skilled in the art without departing from the relevant scope as defined in the enclosed claims.

1. Method for the reconstruction of holographic images in Digital Holography, comprising the following steps:
A hologram of an investigated object is detected and recorded at a distance d from it, by a detection device that is constituted by an integrated array of image detection elements, that spatially sample the hologram with a number N of pixels along the x-axis of the hologram plane, each having length Δx, and a number M of pixels along the y-axis of the hologram plane, each having length Δy, thus obtaining a rectangular array of a number Vᵣ=N·M of values proportional to light intensity values of the hologram, such a rectangular array being called a “digital hologram” h(x,y);
Starting from the digital hologram, the same hologram, or a portion of it corresponding e.g. to an object image, is reconstructed in the reconstruction plane, at a distance D from the hologram plane, using the usual diffraction Fresnel propagation integral, i.e. discrete Fresnel transform;
The method being characterised in that, if one chooses that D≠d, the reconstruction of the hologram comprises the following sub-steps:
A. A geometric transformation, realized by introducing pixels having intensity values that are interpolated between the adjacent ones, is applied to the recorded digital hologram h(x,y), or a portion thereof, to obtain a transformed digital hologram h(x′,y′);
B. The discrete Fresnel Transform is performed on the transformed digital hologram h(x′,y′) or portion thereof to obtain the reconstructed digital hologram at distance D.

2. Method according to claim 1, characterised in that the transformed digital hologram h(x′,y′) is obtained by a polynomial transformation of the coordinates x′=Polₙ(x,y), y′=Pol′ₙ(x,y) where Polₙ(x,y), Pol′ₙ(x,y) is a polynomial of order n.

3. Method according to claim 2, characterised in that Polₙ(x,y) is a polynomial of order 2, i.e. a parabolic function.

4. Method according to claim 2, characterised in that Polₙ(x,y) is a polynomial of order 1, i.e. a linear function, in particular y′=αy and x′=αx, thus obtaining that D=α²d, with α that is a real number.

5. Method according to claim 1, characterised in that different portions of a digital hologram undergo step A for different reconstruction distances D, each portion being deformed by means of a specific transformation function, so as to obtain a final hologram image wherein said different portions are all in focus.

6. Method for the reconstruction of holographic images in Digital Holography, comprising the following steps:
A hologram of an investigated object is detected and recorded at a distance d from it, by a detection device that is constituted by an integrated array of image detection elements, that spatially sample the hologram with a number N of pixels along the x-axis of the hologram plane, each having length Δx, and a number M of pixels along the y-axis of the hologram plane, each having length Δy, thus obtaining a rectangular array of a number Vᵣ=N·M of values proportional to light intensity values of the hologram, such a rectangular array being called a “digital hologram” h(x,y);
Starting from the digital hologram, the same hologram, or a portion of it corresponding e.g. to an object image, is reconstructed in the reconstruction plane, at a distance D from the hologram plane, using the usual diffraction Fresnel propagation integral, i.e. discrete Fresnel transform;
The method being characterised in that, if one chooses that D≠d, the reconstruction of the hologram comprises the following sub-steps:
A. A geometric transformation, realized by introducing pixels having intensity values that are interpolated between the adjacent ones, is applied to the recorded digital hologram h(x,y), or a portion thereof, to obtain transformed digital holograms h(x′,y′);
B. the transformed digital holograms h(x′,y′) are projected onto a SLM optic reconstruction device, so as to obtain their subsequent visualization as forward and/or backward move along the optical axis, thus creating a dynamical three-dimensional scene.

7. Method according to claim 6, characterised in that step A is performed in parallel for several different digital holograms h(x,y) of a different position of an object with respect to the detection device, and the results are composed in an only whole digital hologram, so as to obtain the effect of different portions of said whole hologram being moved back and/or forth along the optical axis and turned around themselves, thus creating a dynamical 3D scene.

8. Method for the reconstruction of holographic images in Digital Holography, comprising the following steps:
A hologram of an investigated object is detected and recorded at a distance d from it, by a detection device that is constituted by an integrated array of image detection elements, that spatially sample the hologram with a number N of pixels along the x-axis of the hologram plane, each having length Δx, and a number M of pixels along the y-axis of the hologram plane, each having length Δy, thus obtaining a rectangular array of a number Vᵣ=N·M of values proportional to light intensity values of the hologram, such a rectangular array being called a “digital hologram” h(x,y);
Starting from the digital hologram, the same hologram, or a portion of it corresponding e.g. to an object image, is reconstructed in the reconstruction plane, using the usual discrete Fourier transform of the diffraction;
The method being characterised in that, when the object is tilted with respect to the hologram plane, and the points of its surface are at a distance D=2αdl′, wherein l′ represents the coordinate along the slope of the object tilted with respect to the hologram plane, the reconstruction of the hologram comprises the following steps:
A. a deformation f(x)=x+αx², with a an arbitrary real number, is applied to the recorded digital hologram h(x,y) or a portion thereof, the deformation being realized by introducing pixels having intensity values interpolated between the adjacent ones, to obtain a transformed digital hologram h(x′,y′);
B. the discrete Fourier transformation is performer on the transformed digital hologram h(x′,y′) or a portion thereof in order to obtain the reconstructed digital hologram for all the points of said inclined surface that find themselves at the distance D=2αdl′, thus obtaining all the points of said surface simultaneously in focus.

9. Method according to claim 1, characterised in that:
step A is performed for several holograms detected by different light wavelengths, thus appearing with different pixel's size, to obtain the same size for the holograms, i.e. the same reconstruction distance D,
The holograms so reconstructed being superposed, thus obtaining an in-focus color Digital Holography image.

10. Computer program characterised in that it comprises code means apt to execute, when running on a computer, the method according to claim 1.

11. Memory medium, readable by a computer, storing a program, characterised in that the program is the computer program according to claim 10.

12. Apparatus for detection of holographic images, comprising an integrated array of image detection devices and a digitized hologram processing unit, characterised in that the processing unit processes the data detected by said a detection device by using the method according to claim 1.
